(19) United States
(12) Patent Application Publication
(10) Pub. No.: US 2019/0299428 A1
(43) Pub. Date: Oct. 3, 2019

(54) ROBOT, PRINTER, AND OPTICAL SIGNAL TRANSMISSION APPARATUS

(71) Applicant: Seiko Epson Corporation, Tokyo (JP)

(72) Inventor: Hitoshi NAKAYAMA, Shiojiri (JP)

(21) Appl. No.: 16/372,639

(22) Filed: Apr. 2, 2019

(30) Foreign Application Priority Data
Apr. 3, 2018 (JP) 2018-071380

(51) Int. Cl. B25J 19/02; G01S 17/08; B25J 13/08

(52) U.S. Cl. CPC B25J 19/021; B25J 13/08; G01S 17/08

(57) ABSTRACT

A robot includes an optical signal transmission apparatus that transmits optical signals. The optical signal transmission apparatus includes a light emitting device that emits light, a light receiving device that receives light and outputs a signal, and an amplifier circuit that amplifies the signal output from the light receiving device, wherein the amplifier circuit is placed between the light emitting device and the light receiving device. Further, a distance between the light receiving device and the amplifier circuit is smaller than a distance between the light emitting device and the amplifier circuit.

The present application is based on, and claims priority from JP Application Serial Number 2018-071380, filed Apr. 3, 2018, the disclosure of which is hereby incorporated by reference herein in its entirety.

### BACKGROUND

### 1. Technical Field

The present disclosure relates to a robot, printer, and optical signal transmission apparatus.

### 2. Related Art

For example, as an optical signal transmission apparatus that can switch between an electrical signal and an optical signal, an optical communication module described in JP-A-2013-21543 is known. The optical communication module described in JP-A-2013-21543 includes a laser diode, a photodiode, and a transimpedance amplifier that converts a current signal from the photodiode into a voltage signal.

JP-A-2013-21543 is an example of the related art.

However, in the optical communication module of JP-A-2013-21543 having the above described configuration, it is difficult to downsize the apparatus because the transimpedance amplifier is placed behind the laser diode and the photodiode.

### SUMMARY

A robot according to an aspect of the present disclosure includes an optical signal transmission apparatus that transmits optical signals, the optical signal transmission apparatus includes a light emitting device that emits light, a light receiving device that receives light and outputs a signal, and an amplifier circuit that amplifies the signal output from the light receiving device, wherein the amplifier circuit is placed between the light emitting device and the light receiving device.

### BRIEF DESCRIPTION OF THE DRAWINGS

FIG. 1 is a perspective view showing a robot according to a first embodiment of the present disclosure.

FIG. 2 shows an arrangement of optical signal transmission apparatuses of the robot.

FIG. 3 is a side view showing the optical signal transmission apparatus.

FIG. 4 is a top view of a first board of the optical signal transmission apparatus.

FIG. 5 is a top view of a package of the optical signal transmission apparatus.

FIG. 6 is a sectional view along line A-A in FIG. 5.

FIG. 7 is a sectional view of a photoelectric conversion unit of the optical signal transmission apparatus.

FIG. 8 is a sectional view of the photoelectric conversion unit of the optical signal transmission apparatus.

FIG. 9 is a top view of the first board of the optical signal transmission apparatus.

FIG. 10 is a bottom view of a second board of the optical signal transmission apparatus.

FIG. 11 is a block diagram showing a connection state between the optical signal transmission apparatus and electronic components.

FIG. 12 is a sectional view showing a modified example of the optical signal transmission apparatus.

FIG. 13 is a sectional view showing a modified example of the optical signal transmission apparatus.

FIG. 14 is a side view showing a modified example of the optical signal transmission apparatus.

FIG. 15 is a sectional view of an optical signal transmission apparatus according to a second embodiment of the present disclosure.

FIG. 16 is a schematic diagram showing an overall configuration of a printer according to a third embodiment of the present disclosure.

FIG. 17 is a block diagram showing a control apparatus of the printer shown in FIG. 16.

### DESCRIPTION OF EXEMPLARY EMBODIMENTS

As below, a robot, printer, and optical signal transmission apparatus according to the present disclosure will be explained in detail based on embodiments shown in the accompanying drawings.

### First Embodiment

First, a robot and optical signal transmission apparatus according to the first embodiment of the present disclosure are explained.

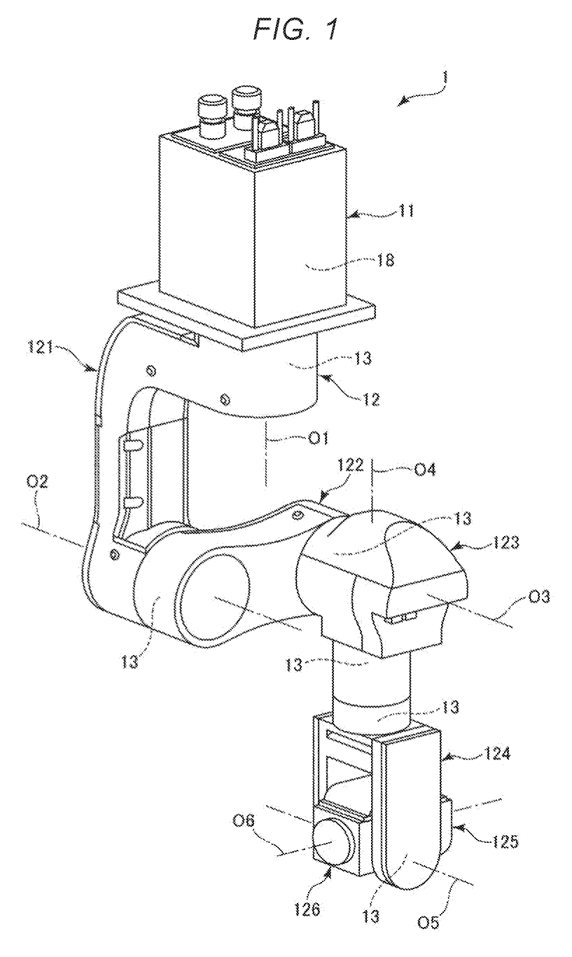

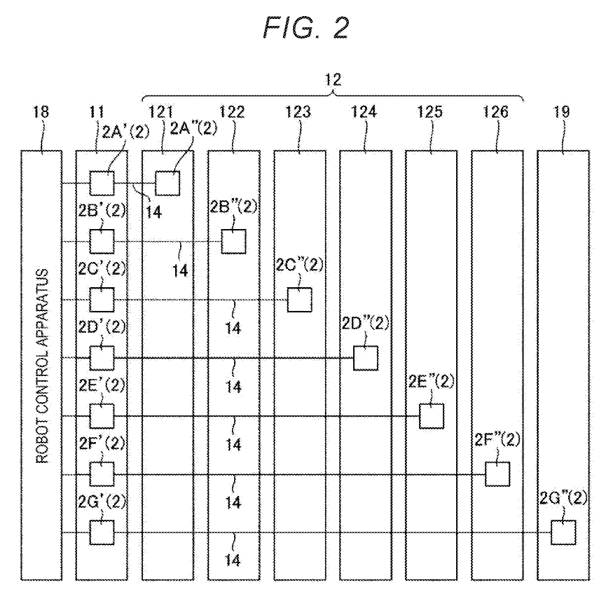

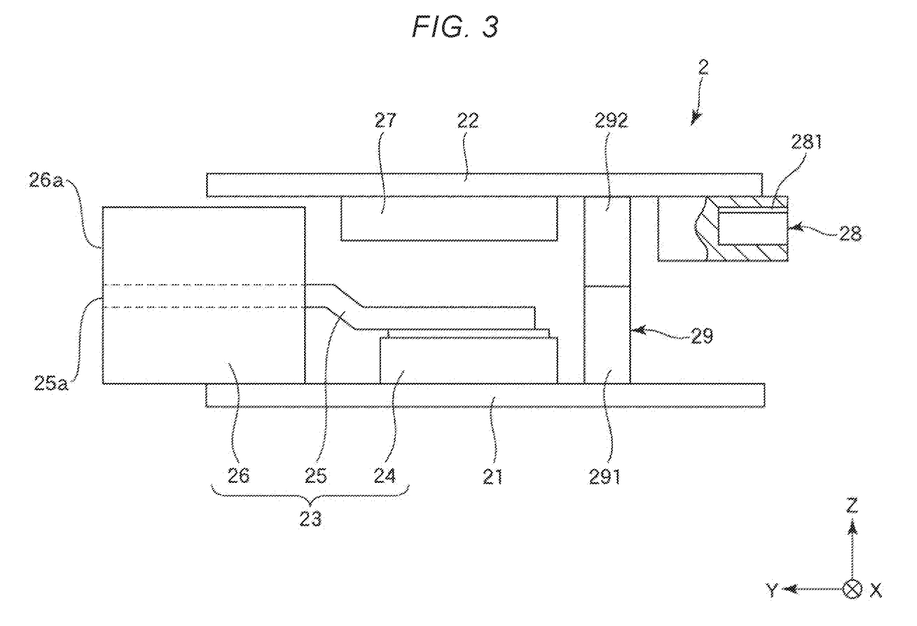

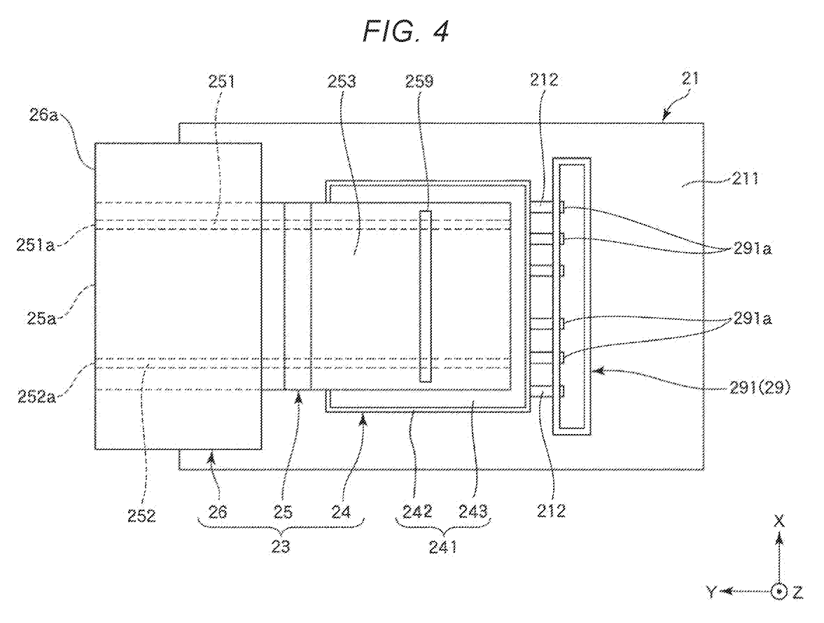

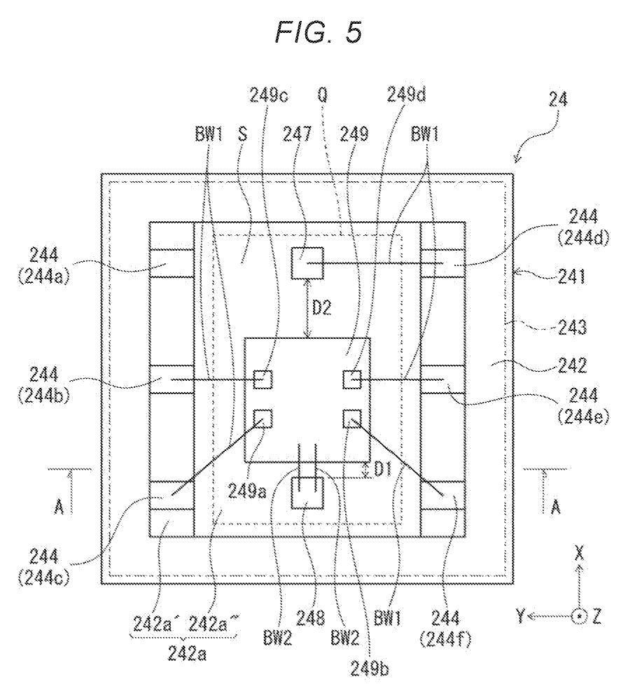

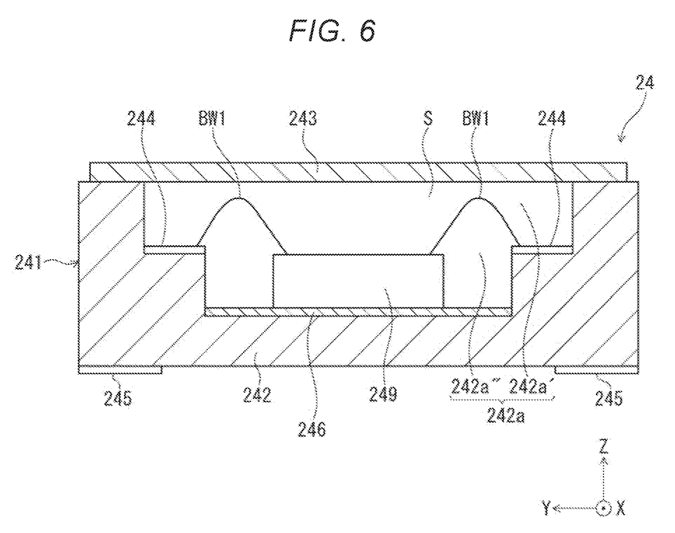

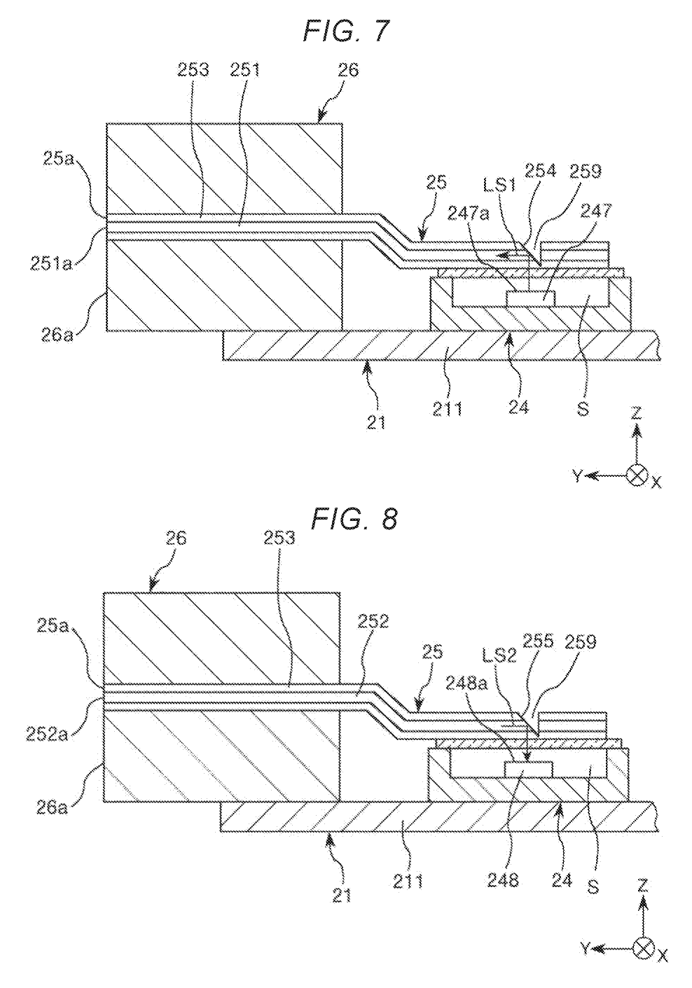

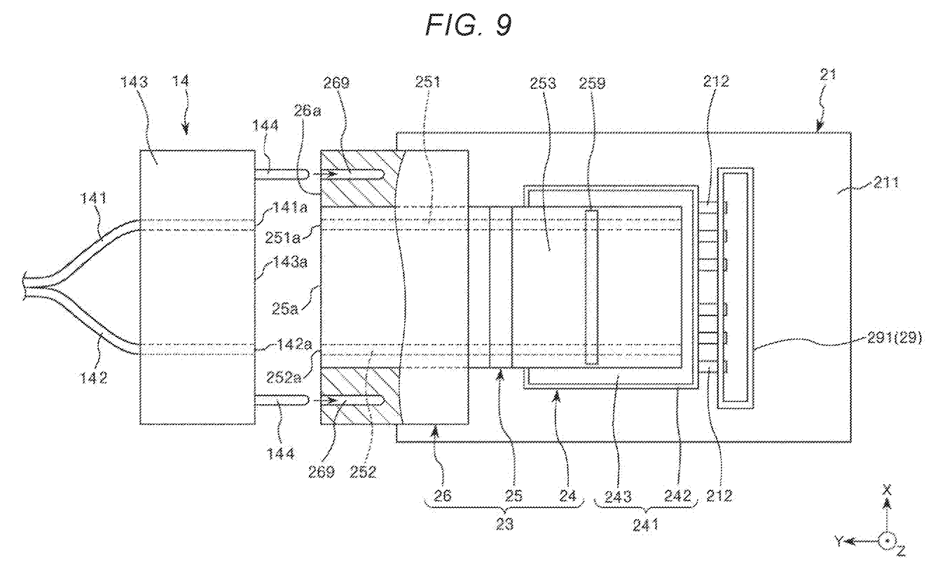

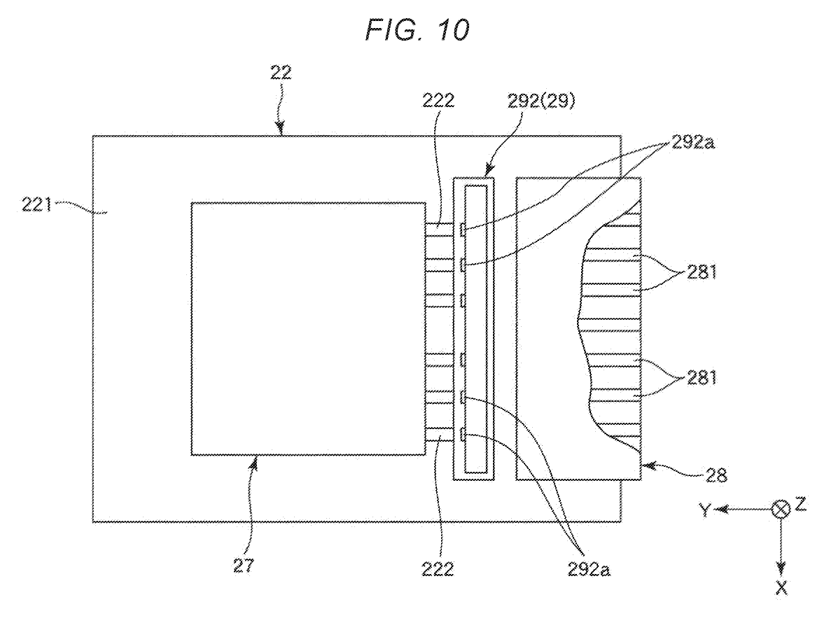

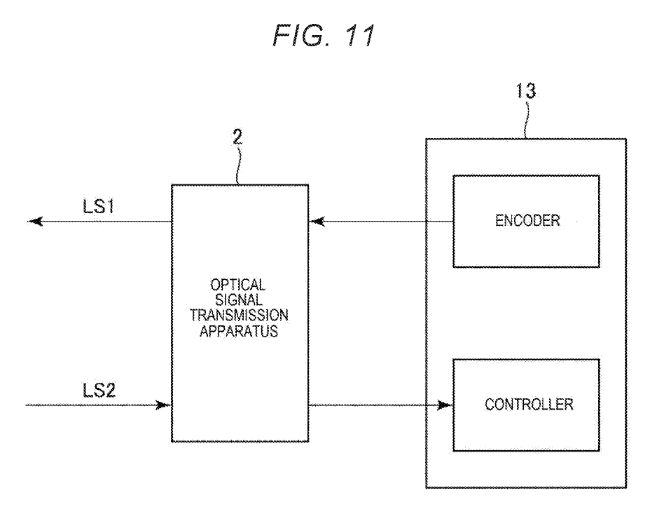

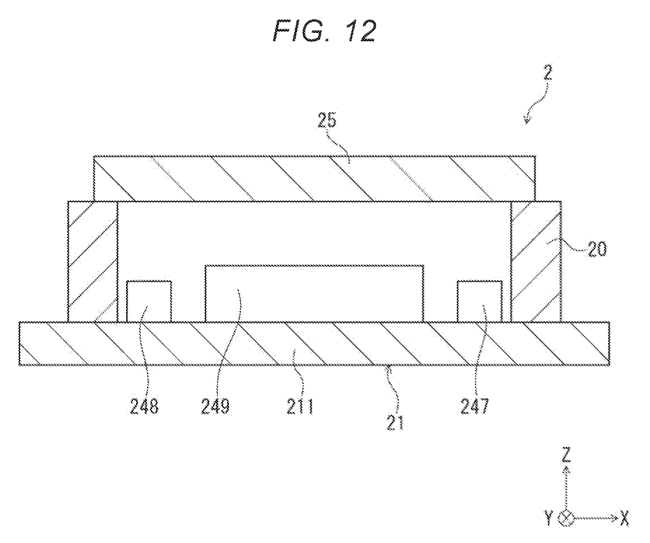

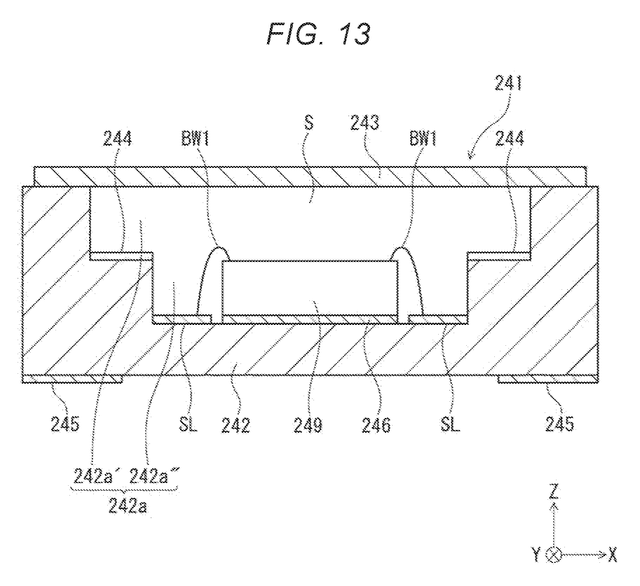

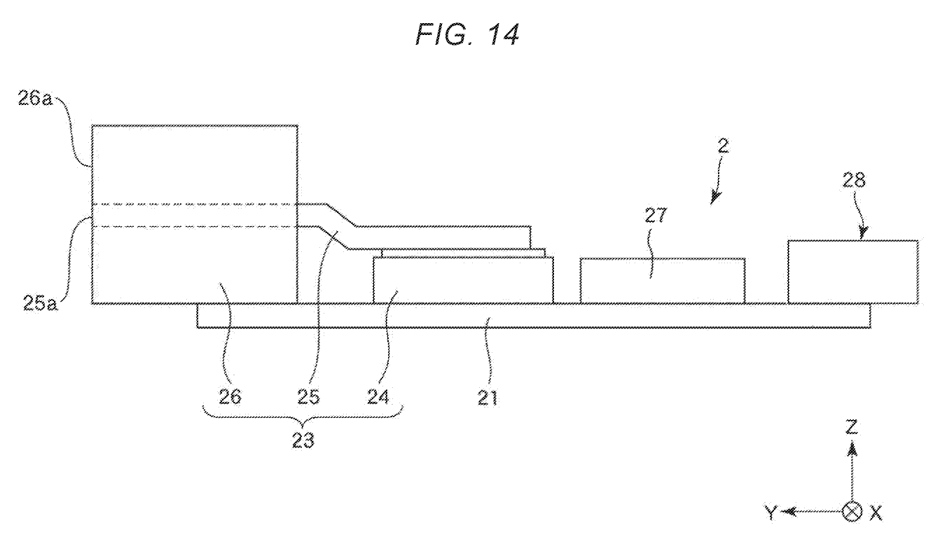

FIG. 1 is a perspective view showing the robot according to the first embodiment of the present disclosure. FIG. 2 shows an arrangement of optical signal transmission apparatuses of the robot. FIG. 3 is a side view showing the optical signal transmission apparatus. FIG. 4 is a top view of a first board of the optical signal transmission apparatus. FIG. 5 is a top view of a package of the optical signal transmission apparatus. FIG. 6 is a sectional view along line A-A in FIG. 5. FIGS. 7 and 8 are respectively sectional views of a photoelectric conversion unit of the optical signal transmission apparatus. FIG. 9 is a top view of the first board of the optical signal transmission apparatus. FIG. 10 is a bottom view of a second board of the optical signal transmission apparatus. FIG. 11 is a block diagram showing a connection state between the optical signal transmission apparatus and electronic components. FIGS. 12 and 13 are sectional views showing modified examples of the optical signal transmission apparatus. FIG. 14 is a side view showing a modified example of the optical signal transmission apparatus.

Note that, hereinafter, for convenience of explanation, three axes orthogonal to one another are referred to as “X-axis”, “Y-axis, and “Z-axis”, and directions parallel to the X-axis are also referred to as “X-axis directions (first directions)”, directions parallel to the Y-axis are also referred to as “Y-axis directions (second directions)”, and directions parallel to the Z-axis are also referred to as “Z-axis directions (third directions)”. The tip end sides in directions of arrows of the respective axes are also referred to as “plus sides” and the tail end sides are also referred to as “minus sides”. Further, the plus side in the Z-axis direction is also referred to as “upper” and the minus side in the Z-axis direction is also referred to as “lower”. Furthermore, the plus side in the Y-axis direction is also referred to as “tip end side” and the minus side is also referred to as “base end side”. A plan view as seen from the Z-axis direction is also simply referred to as “plan view”.

A robot 1 shown in FIG. 1 may perform e.g. work including supply, removal, carrying, and assembly of precision apparatuses and parts forming the apparatuses. Note that the application of the robot 1 is not limited to that. The robot 1 is a vertical articulated robot. The robot 1 has a base 11 and a robot arm 12. Further, the robot arm 12 has a first arm 121, a second arm 122, a third arm 123, a fourth arm 124, a fifth arm 125, and a sixth arm 126.

The base 11 is fixed to e.g. a floor, wall, ceiling, or the like. The first arm 121 is pivotal about a first pivot axis O1 relative to the base 11. The second arm 122 is pivotal about a second pivot axis O2 orthogonal to the first pivot axis O1 relative to the first arm 121. The third arm 123 is pivotal about a third pivot axis O3 parallel to the second pivot axis O2 relative to the second arm 122. The fourth arm 124 is pivotal about a fourth pivot axis O4 orthogonal to the third pivot axis O3 relative to the third arm 123. The fifth arm 125 is pivotal about a fifth pivot axis O5 orthogonal to the fourth pivot axis O4 relative to the fourth arm 124. The sixth arm 126 is pivotal about a sixth pivot axis O6 orthogonal to the fifth pivot axis O5 relative to the fifth arm 125.

Regarding the first pivot axis O1 to the sixth pivot axis O6, “orthogonal” includes the cases where an angle formed by two axes is within a range of ±5° from 90°, and “parallel” includes the cases where one of two axes is inclined within a range of ±5° relative to the other.

In the robot 1, an end effector such as a robot hand 19 (not shown in FIG. 1) that grips e.g. a precision apparatus, a part, or the like may be detachably attached to the distal end part of the sixth arm 126. Further, the robot 1 has a robot control apparatus 18 such as a personal computer that controls operations of the respective parts of the robot 1. Furthermore, the robot 1 has drive devices 13 placed in the respective coupling parts of the base 11 and the first arm 121 to the sixth arm 126. Each drive device 13 has e.g. a motor as a drive source of the arm, a controller that controls driving of the motor, a reducer, an encoder, etc.

As shown in FIG. 2, the robot 1 has a plurality of optical signal transmission apparatuses 2 placed inside thereof. The plurality of optical signal transmission apparatuses 2 include optical signal transmission apparatuses 2A′, 2B′, 2C′, 2D′, 2E′, 2F′, 2G′ placed within the base 11, an optical signal transmission apparatus 2A″ placed within the first arm 12 and optically connected to the optical signal transmission apparatus 2A′ via an optical interconnection 14, an optical signal transmission apparatus 2B″ placed within the second arm 122 and optically connected to the optical signal transmission apparatus 2B′ via an optical interconnection 14, an optical signal transmission apparatus 2C″ placed within the third arm 123 and optically connected to the optical signal transmission apparatus 2C′ via an optical interconnection 14, an optical signal transmission apparatus 2D″ placed within the fourth arm 124 and optically connected to the optical signal transmission apparatus 2D′ via an optical interconnection 14, an optical signal transmission apparatus 2E″ placed within the fifth arm 125 and optically connected to the optical signal transmission apparatus 2E′ via an optical interconnection 14, an optical signal transmission apparatus 2F″ placed within the sixth arm 126 and optically connected to the optical signal transmission apparatus 2F′ via an optical interconnection 14, and an optical signal transmission apparatus 2G″ placed within the robot hand 19 and optically connected to the optical signal transmission apparatus 2G′ via an optical interconnection 14. Note that “optically connected” may be also expressed by “optically communicably connected”.

Note that, as long as the robot 1 has at least one optical signal transmission apparatus 2, part of the optical signal transmission apparatuses 2A′, 2A″, 2B′, 2B″, 2C′, 2C″, 2D′, 2D″, 2E′, 2E″, 2F′, 2F″, 2G′, 2G″ (hereinafter, for convenience of explanation, also referred to as “optical signal transmission apparatuses 2A′ to 2G”) may be omitted. Further, the optical signal transmission apparatuses 2A′ to 2G″ may be not placed inside of the robot 1, but placed to be exposed outside of the robot 1. The optical signal transmission apparatuses 2A′ to 2G″ have the same configuration as one another and these will be collectively explained as the optical signal transmission apparatus 2.

The optical signal transmission apparatus 2 has a function of transmitting and receiving optical signals. As shown in FIG. 3, the optical signal transmission apparatus 2 has a first board 21, a second board 22, a photoelectric conversion unit 23 placed on the first board 21, a circuit element 27 and a terminal part 28 placed on the second board 22, and a board coupling part 29 coupling the first board 21 and the second board 22.

As shown in FIG. 4, the first board 21 has a hard base portion 211 and a plurality of wires 212 placed on the base portion 211. The base portion 211 is not particularly limited, but various rigid printed wiring boards including e.g. a paper phenol board, paper epoxy board, glass composite board, glass epoxy board, ceramics board, and low-temperature co-fired ceramics (LTCC) board may be used.

As shown in FIGS. 3 and 4, the photoelectric conversion unit 23 is placed on the upper surface of the first board 21. The photoelectric conversion unit 23 has an optical element 24, an optical waveguide 25, and a connector 26. The optical element 24 has a function of generating a first optical signal LS1 converted from an electrical signal and a function of receiving and converting a second optical signal LS2 into an electrical signal. As shown in FIG. 5, the optical element 24 has a package 241, and a light emitting device 247, a light receiving device 248, and an amplifier circuit 249 accommodated in the package 241. The element generates the first optical signal LS1 using the light emitted from the light emitting device 247, and receives the second optical signal LS2 using the light receiving device 248.

As shown in FIG. 6, the package 241 has a base 242 with a concave portion 242a opening toward the upper surface side, and a lid 243 in a plate shape which is joined to the upper surface of the base 242 and serves as a light-transmissive portion closing the opening of the concave portion 242a. Further, the concave portion 242a has a first concave portion 242a′ with an opening in the upper surface of the base 242, and a second concave portion 242a″ with an opening in the bottom surface of the first concave portion 242a′. That is, the bottom surface of the second concave portion 242a″ is placed on the minus side in the Z-axis direction with respect to the bottom surface of the first concave portion 242a′ at a longer distance from the upper surface of the base 242. The opening of the concave portion 242a is closed by the lid 243, and thereby, an air-tight internal space S is formed inside of the package 241 and the light emitting device 247, the light receiving device 248, and the amplifier circuit 249 are housed in a sealed state in the internal space S.

Note that the atmosphere of the internal space S is not particularly limited, but preferably a nitrogen atmosphere, for example. Thereby, light loss within the internal space S may be suppressed and intensity decrease of the first optical signal LS1 and the second optical signal LS2 within the internal space S may be suppressed.

The constituent material of the base 242 is not particularly limited, but various ceramics e.g. oxide ceramics such as alumina, silica, titania, or zirconia, nitride ceramics such as silicon nitride, aluminum nitride, titanium nitride, etc. may be used. Thereby, the base 242 having a sufficient strength may be obtained. Further, for example, the effect of blocking heat outside of the package 241 may be increased and a temperature rise within the internal space S may be suppressed. Accordingly, for example, decrease of drive efficiency of the light emitting device 247 with the temperature rise may be suppressed and the first optical signal LS1 having predetermined intensity may be stably emitted.

A plurality of internal terminals 244 are provided on the bottom surface of the first concave portion 242a′, a GND electrode 246 at a ground potential is provided on the bottom surface of the second concave portion 242a″, and a plurality of external terminals 245 are provided on the lower surface of the base 242. The plurality of internal terminals 244 and the GND electrode 246 are respectively electrically coupled to the corresponding external terminals 245 via internal wires (not shown) formed on the base 242. Further, the internal terminals 244 are electrically coupled to the light emitting device 247 and the amplifier circuit 249 via bonding wires BW1.

The base 242 is fixed to the upper surface of the first board 21 via a joining member (not shown) of a conducting adhesive, solder, brazing filler metal, or the like, and the respective external terminals 245 are electrically coupled to predetermined wires 212 via the joining member.

The light emitting device 247, the light receiving device 248, and the amplifier circuit 249 are respectively placed on the bottom surface of the second concave portion 242a″ (on the GND electrode 246). The light emitting device 247, the light receiving device 248, and the amplifier circuit 249 are respectively joined to the bottom surface of the second concave portion 242a″ via conducting joining members (not shown) such as Ag paste or Au paste, and electrically coupled to the GND electrode 246 via the conducting joining members.

The light emitting device 247 has a light emitting surface 247a on the upper surface thereof and emits light toward the plus side in the Z-axis direction. The light emitting device 247 is not particularly limited as long as the device may emit light, but e.g. a surface-emitting laser (VCSEL), laser diode (LD), LED, or the like may be used. The light receiving device 248 is also called a photoelectric conversion element, and has a light receiving surface 248a on the upper surface thereof. The light receiving device 248 is not particularly limited as long as the device may output a current signal according to the received light, but e.g. a photodiode may be used. The amplifier circuit 249 is e.g. a transimpedance amplifier (TIA), and impedance-converts and amplifies the current signal output by the light receiving device 248 and outputs as a voltage signal.

The light emitting device 247, the light receiving device 248, and the amplifier circuit 249 are arranged along the X-axis direction. Further, the light emitting device 247 and the light receiving device 248 are arranged with the amplifier circuit 249 in between. Specifically, the light emitting device 247 is placed on one side (plus side) of the amplifier circuit 249 in the X-axis direction, and the light receiving device 248 is placed on the other side (minus side) in the X-axis direction. As described above, the amplifier circuit 249 is placed between the light emitting device 247 and the light receiving device 248, and thereby, the light emitting device 247 and the light receiving device 248 may be placed as far away as possible from each other within the internal space S. Accordingly, for example, the light emitted from the light emitting device 247 and received by the light receiving device 248 may be reduced and the second optical signal LS2 may be received with higher accuracy. Furthermore, the amplifier circuit 249 is placed in the space between the light emitting device 247 and the light receiving device 248 produced by placement of the devices as far away as possible from each other within the internal space S, and thereby, the space within the internal space S may be effectively utilized. Accordingly, the package 241 may be downsized. As described above, the amplifier circuit 249 is placed between the light emitting device 247 and the light receiving device 248, and thereby, the optical element 24 may be downsized with suppressed degradation of the optical characteristics of the optical element 24.

Note that, in the embodiment, the centers of the light emitting device 247, the light receiving device 248, and the amplifier circuit 249 are linearly arranged along the X-axis direction, however, not limited to that. For example, one pair of the light emitting device 247 and the light receiving device 248, the light emitting device 247 and the amplifier circuit 249, and the light receiving device 248 and the amplifier circuit 249 may be shifted in the Y-axis direction or the Z-axis direction.

The amplifier circuit 249 and the light receiving device 248 are electrically coupled via bonding wires BW2. Here, the amplifier circuit 249 is placed closer to the light receiving device 248 side than the light emitting device 247. That is, a separation distance D1 between the amplifier circuit 249 and the light receiving device 248 is smaller than a separation distance D2 between the amplifier circuit 249 and the light emitting device 247. The relationship D1<D2 is satisfied, and thereby, for example, compared to the case where D1=D2, the amplifier circuit 249 and the light receiving device 248 may be placed closer to each other, and the bonding wires BW2 electrically coupling the circuit and the device may be made shorter. Accordingly, noise is harder to be mixed into the current signal output from the light receiving device 248 via the bonding wires BW2, and the current signal output from the light receiving device 248 may be converted into the voltage signal with higher accuracy. Note that the relationship between D1 and D2 is not particularly limited, but D1≥D2 may hold.

Here, returning to the explanation of the plurality of internal terminals 244 provided on the base 242, as shown in FIG. 5, the plurality of internal terminals 244 are arranged on both sides of an area Q in the Y-axis direction with the area Q in which the light emitting device 247, the light receiving device 248, and the amplifier circuit 249 are placed in between. Specifically, the three internal terminals 244 are arranged along the X-axis direction on the plus side of the area Q in the Y-axis direction, and the three internal terminals 244 are arranged along the X-axis direction on the minus side of the area Q in the Y-axis direction. As described above, the plurality of internal terminals 244 are arranged on both sides in the Y-axis direction of the area Q having a longitudinal direction in the X-axis direction, and thereby, the package 241 may be spread in the X-axis direction and the Y-axis direction with balance compared to other arrangement, and the package 241 may be downsized. Further, the respective internal terminals 244 are arranged as close to the light emitting device 247 and the amplifier circuit 249 as possible compared to other arrangement, and thereby, the bonding wires BW1 may be made shorter and noise is harder to be mixed via the bonding wires BW1.

Note that the plan view shape of the package 241 is not particularly limited, but substantially a square shape in the embodiment. Further, the size of the package 241 is not particularly limited, but the length in the X-axis direction×the length in the Y-axis direction may be from 3.0 mm×3.0 mm to 10.0 mm×10.0 mm, for example. Thereby, the light emitting device 247 and the light receiving device 248 may be placed sufficiently separately and the sufficiently downsized package 241 may be obtained.

The three internal terminals 244 arranged on the plus side of the area Q in the Y-axis direction and the three internal terminals 244 arranged on the minus side of the area Q in the Y-axis direction are placed symmetrically with respect to the area Q. Thereby, the following advantages may be offered. Note that, hereinafter, the three internal terminals 244 arranged on the plus side of the area Q in the Y-axis direction are also referred to as 244a, 244b, 244c from the plus side in the X-axis direction, and the three internal terminals 244 arranged on the minus side of the area Q in the Y-axis direction are also referred to as 244d, 244e, 244f from the plus side in the X-axis direction.

For example, in the amplifier circuit 249 of the embodiment, at least a VDD terminal 249a to which a power supply voltage is applied, an RSSI (Received Signal Strength Indicator) terminal 249b for detecting a received signal intensity level, a non-inverting voltage output terminal 249c, and an inverting voltage output terminal 249d are provided. Further, the VDD terminal 249a and the internal terminal 244c, the RSSI terminal 249b and the internal terminal 244f, the non-inverting voltage output terminal 249c and the internal terminal 244b, and the inverting voltage output terminal 249d and the internal terminal 244e are respectively coupled via the bonding wires BW1. In the embodiment, the internal terminal 244b coupled to the non-inverting voltage output terminal 249c and the internal terminal 244e coupled to the inverting voltage output terminal 249d are symmetrically placed with respect to the area Q, and thereby, the bonding wire BW1 coupling the non-inverting voltage output terminal 249c and the internal terminal 244b and the bonding wire BW1 coupling the inverting voltage output terminal 249d and the internal terminal 244e have substantially the same length. Accordingly, the output signal from the non-inverting voltage output terminal 249c and the output signal from the inverting voltage output terminal 249d are further amplified by the operational amplifier, and thereby, the electrical signal with high accuracy based on the second optical signal LS2 may be generated.

Of the two internal terminals 244a, 244d not electrically coupled to the amplifier circuit 249, the internal terminal 244d is electrically coupled to the light emitting device 247 via the bonding wire BW1. Therefore, the drive signal is applied to the light emitting device 247 via the internal terminal 244. On the other hand, the internal terminal 244a is coupled to the GND electrode 246 via internal wiring (not shown) and not used in the embodiment.

Note that, in the embodiment, the plurality of internal terminals 244 are arranged on both sides of the area Q in the Y-axis direction with the area Q in which the light emitting device 247, the light receiving device 248, and the amplifier circuit 249 are placed in between, however, may be arranged on both sides of the area Q in the X-axis direction.

As shown in FIG. 6, the lid 243 has a plate-like shape and joined to the upper surface of the base 242 to close the opening of the concave portion 242a of the base 242. The method of joining the lid 243 and the base 242 is not particularly limited, but joining via low-melting-point glass may be used, for example.

The constituent material of the lid 243 is not particularly limited as long as the material may transmit the first optical signal LS1 and the second optical signal LS2, but e.g. various glass materials, various resin materials may be used. For the constituent material of the lid 243, various glass materials are preferably used. The lid 243 is formed using a glass material, and thereby, the substantially clear and colorless lid 243 having a good light-transmissive property may be easily obtained. The glass material is not particularly limited to, but includes e.g. quartz glass and borosilicate glass. Note that anti-reflection films for reducing reflection of light may be formed on the upper surface and the lower surface of the lid 243.

The optical waveguide 25 is optically connected to the optical element 24. As shown in FIG. 4, the optical waveguide 25 has a belt-like shape extending in the Y-axis direction, and the base end portion of the belt-like shape is located on the lid 243. The optical waveguide 25 is joined to the upper surface of the lid 243 via an adhesive (not shown) in the base end portion.

Further, the optical waveguide 25 has a first optical transmission line 251 for propagating the first optical signal LS1, a second optical transmission line 252 for propagating the second optical signal LS2, and a base part 253 covering the first optical transmission line 251 and the second optical transmission line 252. The optical waveguide 25 is a polymer optical waveguide (organic optical waveguide) formed using a polymer. Thereby, the optical waveguide 25 may be formed relatively easily and light may be efficiently propagated. Note that the polymer optical waveguide refers to an optical waveguide formed using a polymeric material and also called a polymeric optical waveguide or plastic optical waveguide, and distinguished from an inorganic optical waveguide formed principally using glass. As the optical waveguide 25, an inorganic optical waveguide, i.e., another optical waveguide than the polymer optical waveguide may be used.

The first optical transmission line 251 is substantially clear and colorless and has a higher refractive index than the base part 253. Accordingly, the first optical signal LS1 entering the first optical transmission line 251 propagates while being totally reflected and confined in the first optical transmission line 251. Similarly, the second optical transmission line 252 is substantially clear and colorless and has a higher refractive index than the base part 253. Accordingly, the second optical signal LS2 entering the second optical transmission line 252 propagates while being totally reflected and confined in the second optical transmission line 252.

The first optical transmission line 251 extends along the Y-axis direction and a tip end surface 251a thereof is exposed in a tip end surface 25a of the optical waveguide 25. Further, as shown in FIG. 7, in a plan view, the first optical transmission line 251 has a portion overlapping with the light emitting surface 247a of the light emitting device 247 and, in the overlapping portion, a first reflection part 254 that reflects the light (first optical signal LS1) emitted from the light emitting device 247 and guiding the light to the first optical transmission line 251 is formed.

The second optical transmission line 252 extends in the Y-axis direction side by side with the first optical transmission line 251 in the X-axis direction. As shown in FIG. 8, a tip end surface 252a of the second optical transmission line 252 is exposed in the tip end surface 25a of the optical waveguide 25. Further, in a plan view, the second optical transmission line 252 has a portion overlapping with the light receiving surface 248a of the light receiving device 248 and, in the overlapping portion, a second reflection part 255 that reflects the light (second optical signal LS2) propagating in the second optical transmission line 252 toward the light receiving surface 248a of the light receiving device 248 is provided.

The constituent materials of the first optical transmission line 251, the second optical transmission line 252, and the base part 253 are not particularly limited as long as the refractive indexes of the first, second optical transmission lines 251, 252 are larger than the refractive index of the base part 253 as described above. For example, various resin materials including acrylic resin, methacrylic resin, polycarbonate, polystyrene, cyclic ether resin such as epoxy resin, oxetane resin, polyamide, polyimide, polybenzoxazole, polysilane, polysilazane, silicone resin, fluorocarbon resin, polyurethane, polyolefin resin, polybutadiene, polyisoprene, polychloroprene, polyester such as PET or PBT, polyethylenesuccinate, polysulfone, polyether, or cyclic olefin resin such as benzocyclobutene resin or norbornene resin may be used, and composite materials formed by combination of at least two different materials may be used.

The configurations of the first, second reflection parts 254, 255 are not particularly limited as long as the parts may reflect light. As shown in FIGS. 7 and 8, in the embodiment, a notch 259 reaching the first, second optical transmission lines 251, 252 is formed and inclined surfaces produced by the notch 259 are used as the first, second reflection parts 254, 255. The notch 259 may be filled with e.g. the same material as that of the base part 253, a metal material such as aluminum.

The connector 26 is a part to which the optical interconnection 14 as an optical transmission line is connected. As shown in FIG. 9, the connector 26 is provided to cover the tip end portion of the optical waveguide 25. Further, the tip end surface 25a of the optical waveguide 25 is exposed from a tip end surface 26a of the connector 26 and, in the embodiment, the tip end surfaces 26a, 25a are substantially flush. The connector 26 has holes 269 located in end portions in the X-axis direction and opening in the tip end surface 26a. The holes 269 are used for guiding connection to the optical interconnection 14 as will be described later.

The optical interconnection 14 has a first optical interconnection 141, a second optical interconnection 142, and a connector 143. As the first optical interconnection 141 and the second optical interconnection 142, e.g. optical fibers may be used. A pair of pins 144 are provided in the connector 143 and the pins 144 are inserted into the holes 269 of the connector 26, and thereby, the connector 143 and the connector 26 are aligned. The connectors 143, 26 are fastened using clips (not shown) with a base end surface 143a of the connector 143 and the tip end surface 26a of the connector 26 in contact, and thereby, the connection state of the connectors may be maintained. The method of fastening the connectors 143, 26 is not particularly limited.

In the state in which the connectors 143, 26 are connected, a base end surface 141a of the first optical interconnection 141 and the tip end surface 251a of the first optical transmission line 251 are opposed and a base end surface 142a of the second optical interconnection 142 and the tip end surface 252a of the second optical transmission line 252 are opposed. Thereby, the first optical interconnection 141 and the first optical transmission line 251 are optically connected and the second optical interconnection 142 and the second optical transmission line 252 are optically connected.

As the connector 26, e.g. an MT connector may be used. Note that the configuration of the connector 26 is not particularly limited as long as the connector may optically connect to the optical interconnection 14.

As shown in FIG. 10, the second board 22 has a hard base part 221 and wires 222 placed on the base part 221. Further, the second board 22 is placed to overlap with (face) the first board 21 in the Z-axis direction. The second board 22 is not particularly limited, but various rigid printed wiring boards including e.g. a paper phenol board, paper epoxy board, glass composite board, glass epoxy board, ceramics board, and low-temperature co-fired ceramics (LTCC) board may be used like the first board 21.

The circuit element 27 is provided on the lower surface of the second board 22 and electrically coupled to the wires 222. The circuit element 27 may execute electrical signal processing and control for the optical element 24. The circuit element 27 includes e.g. an LDD circuit that switches the current to the light emitting device 247, a level conversion circuit that converts the signal level, etc. Note that, in the embodiment, the circuit element 27 formed as a chip is provided on the lower surface of the second board 22, however, the circuit element 27 may be formed by placement of various circuit elements on the lower surface of the second board 22.

The board coupling part 29 has a function of coupling and fastening the first board 21 and the second board 22 and electrically coupling the optical element 24 on the first board 21 and the circuit element 27 on the second board 22. As shown in FIG. 3, the board coupling part 29 has a first board coupling piece 291 fixed to the upper surface of the first board 21 and provided to project toward the second board 22 side and a second board coupling piece 292 fixed to the lower surface of the second board 22 and provided to project toward the first board 21 side. The first board coupling piece 291 is a female connector and, as shown in FIG. 4, has a plurality of terminals 291a electrically coupled to the plurality of wires 212. On the other hand, the second board coupling piece 292 is a male connector that can engage with the first board coupling piece 291 and, as shown in FIG. 10, has a plurality of terminals 292a electrically coupled to the plurality of wires 222.

According to the configuration, the first board coupling piece 291 and the second board coupling piece 292 are coupled, and thereby, the first board 21 and the second board 22 may be fastened. Further, when the first board coupling piece 291 and the second board coupling piece 292 are coupled, the terminals 291a, 292a come into contact, and the wires 212, 222 may be electrically coupled. Thereby, the optical element 24 and the circuit element 27 are electrically coupled.

Note that the configuration of the board coupling part 29 is not particularly limited as long as the part may electrically couple the optical element 24 and the circuit element 27.

The terminal part 28 has a function of electrically coupling the optical signal transmission apparatus 2 to another electronic component. As shown in FIG. 10, the terminal part 28 is provided in the base end portion of the second board 22. Further, the terminal part 28 is provided on the lower surface of the second board 22. The terminal part 28 includes connectors having a plurality of terminals 281 electrically coupled to the circuit element 27 via the wires 222. According to the configuration, the optical signal transmission apparatus 2 and the electronic component may be electrically coupled relatively easily.

Here, the electronic component electrically coupled to the optical signal transmission apparatus 2 via the terminals 281 is not particularly limited to, but includes e.g. the drive device 13 as shown in FIG. 11. In this case, the signal (control signal) transmitted from the robot control apparatus 18 to the controller of the drive device 13 may be transmitted as the second optical signal LS2, and the output signal transmitted from the encoder to the robot control apparatus 18 may be transmitted as the first optical signal LS1. Thereby, the communication speed between the robot control apparatus 18 and the drive device 13 may be made higher.

The electronic component electrically coupled to the optical signal transmission apparatus 2 via the terminals 281 includes e.g. various sensors provided in predetermined locations of the robot 1 in addition to the above described drive device 13. The sensors include e.g. a camera, force sensor, temperature sensor, pressure sensor, etc. In this case, the signal (control signal) transmitted from the robot control apparatus 18 to the sensor may be transmitted as the second optical signal LS2, and the output signal transmitted from the sensor to the robot control apparatus 18 may be transmitted as the first optical signal LS1. Thereby, the communication speed between the robot control apparatus 18 and the sensor may be made higher.

As above, the robot 1 is explained. The robot 1 includes the optical signal transmission apparatus 2 that transmits optical signals. The optical signal transmission apparatus 2 has the light emitting device 247 that emits light, the light receiving device 248 that receives the light and outputs a signal, and the amplifier circuit 249 that amplifies the signal (current signal) output from the light receiving device 248. The amplifier circuit 249 is placed between the light emitting device 247 and the light receiving device 248. The amplifier circuit 249 is placed between the light emitting device 247 and the light receiving device 248, and thereby, the space produced between the devices sufficiently separated so that the light emitted from the light emitting device 247 may not be received by the light receiving device 248 may be effectively used as the placement space of the amplifier circuit 249 and the optical signal transmission apparatus 2 may be downsized.

As described above, the separation distance D1 (distance) between the light receiving device 248 and the amplifier circuit 249 is smaller than the separation distance D2 (distance) between the light emitting device 247 and the amplifier circuit 249. The relationship D1<D2 is satisfied, and thereby, for example, compared to the case where D1=D2, the amplifier circuit 249 and the light receiving device 248 may be placed closer to each other, and the bonding wires BW2 electrically coupling the circuit and the device may be made shorter. Accordingly, noise is harder to be mixed into the current signal output from the light receiving device 248 via the bonding wires BW2, and the current signal output from the light receiving device 248 may be converted into the voltage signal with higher accuracy.

Further, as described above, the first optical transmission line 251 that transmits the light (first optical signal LS1) emitted from the light emitting device 247 and the second optical transmission line 252 that transmits the light (second optical signal LS2) toward the light receiving device 248 are provided. Thereby, the transmission of the first optical signal LS1 and the reception of the second optical signal LS2 may be performed and two-way communication can be made.

As described above, the first optical transmission line 251 and the second optical transmission line 252 are respectively the polymer light waveguides. Thereby, the optical waveguide 25 may be formed relatively easily and the light may be efficiently propagated.

As described above, the optical signal transmission apparatus 2 includes the package 241 having the internal space S, and the light emitting device 247, the light receiving device 248, and the amplifier circuit 249 are housed in the internal space S. Thereby, the light emitting device 247, the light receiving device 248, and the amplifier circuit 249 may be protected from shock etc.

As described above, the internal space S is sealed with the nitrogen atmosphere. Thereby, the light emitting device 247, the light receiving device 248, and the amplifier circuit 249 may be effectively protected from dust, moisture, etc. Particularly, the internal space S is set at reduced pressure, and thereby, intensity decrease of the first optical signal LS1 and the second optical signal LS2 within the internal space S may be suppressed.

As described above, the package 241 has the base 242 with the concave portion 242a, in which the light emitting device 247, the light receiving device 248, and the amplifier circuit 249 are placed on the bottom surface of the concave portion 242a, and the lid 243 joined to the base 242 to close the opening of the concave portion 242a. The base 242 is formed using ceramics. Thereby, the base 242 with the sufficient strength may be obtained. Further, for example, the effect of blocking heat outside of the package 241 may be increased and the temperature rise within the internal space S may be suppressed. Accordingly, for example, decrease of drive efficiency of the light emitting device 247 with the temperature rise may be suppressed and the first optical signal LS1 having the predetermined intensity may be stably emitted.

As described above, when the direction in which the light emitting device 247 and the light receiving device 248 are arranged is the X-axis direction (first direction) and the direction crossing the X-axis direction in a plan view is the Y-axis direction (second direction), the package 241 has the plurality of internal terminals 244 (terminal) arranged on both sides in the Y-axis direction with respect to the area Q in which the light emitting device 247, the light receiving device 248, and the amplifier circuit 249 are placed. The plurality of internal terminals 244 are placed as described above, and thereby, the respective internal terminals 244 may be placed as close to the light emitting device 247 and the amplifier circuit 249 as possible. Accordingly, the bonding wires BW1 coupling the internal terminals 244 and the light emitting device 247 and the bonding wires BW1 coupling the internal terminals 244 and the amplifier circuit 249 may be made shorter and noise is harder to be mixed in via the bonding wires BW1.

Note that the configuration of the optical signal transmission apparatus 2 is not limited to the configuration of the embodiment. For example, in the embodiment, the internal space S is sealed, however, the internal space S may communicate with outside of the package 241. Further, in the embodiment, the light emitting device 247, the light receiving device 248, and the amplifier circuit 249 are housed in the package 241, however, for example, as shown in FIG. 12, the package 241 may be omitted and the light emitting device 247, the light receiving device 248, and the amplifier circuit 249 may be placed on the first board 21. In this case, the optical waveguide 25 may be fixed to the first board 21 via a supporting member 20 also serving as a spacer.

Or, for example, as shown in FIG. 13, strip lines SL may be formed on the bottom surface of the second concave portion 242a″ and the strip lines SL and the light emitting device 247 and amplifier circuit 249 may be electrically coupled via the bonding wires BW1. According to the configuration, the strip lines SL may be formed as close to the light emitting device 247 and the amplifier circuit 249 as possible, and thereby, the bonding wires BW1 may be made shorter than those of the embodiment. Further, the strip lines SL are used, and thereby, it is not necessary to change the shape and size of the original base 242 and increase of the manufacturing cost may be suppressed.

Or, for example, as shown in FIG. 14, the second board 22 and the board coupling part 29 may be omitted from the optical signal transmission apparatus 2 of the embodiment and the circuit element 27 and the terminal part 28 may be placed on the first board 21. In this regard, the circuit element 27 is preferably placed on the base end side of the package 241 (the minus side in the Y-axis direction). In other words, the circuit element 27 is preferably placed on the opposite side to the extension direction of the optical waveguide 25 with respect to the package 241. Thereby, heat of the circuit element 27 is harder to be transferred to the optical waveguide 25 and the optical waveguide 25 is harder to be damaged by heat.

### Second Embodiment

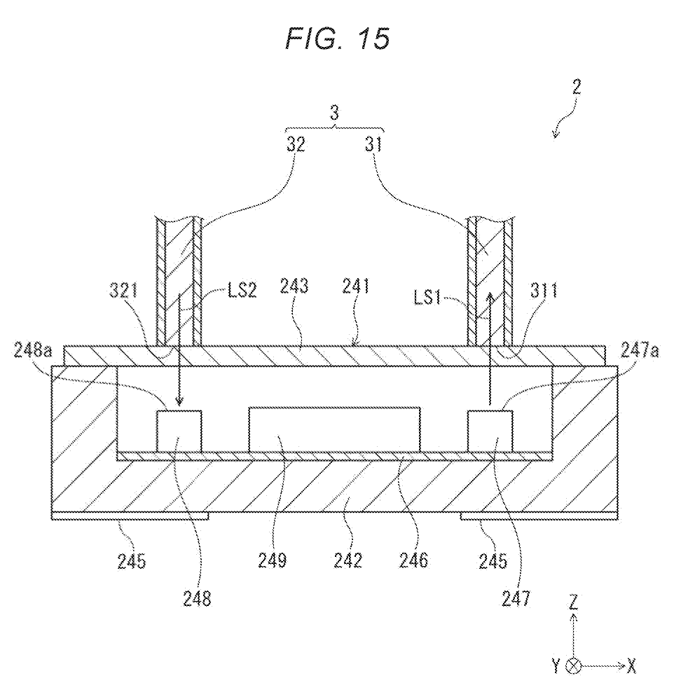

FIG. 15 is a sectional view of an optical signal transmission apparatus according to the second embodiment of the present disclosure.

The optical signal transmission apparatus according to the embodiment is the same as the optical signal transmission apparatus according to the above described first embodiment except that an optical interconnection 3 is used in place of the optical waveguide 25. In the following description, the optical signal transmission apparatus according to the second embodiment will be explained with a focus on the differences from the above described first embodiment and the explanation of the same items will be omitted. Further, in FIG. 15, the same configurations as those of the above described embodiment have the same signs.

As shown in FIG. 15, in the optical signal transmission apparatus 2 of the embodiment, one end of the optical interconnection 3 is connected to the lid 243 of the package 241. For example, the connection between the lid 243 and the optical interconnection 3 may be made via an adhesive or via a connector that can connect to the package 241 or the like.

The optical interconnection 3 has a first optical transmission line 31 and a second optical transmission line 32. Abase end surface 311 of the first optical transmission line 31 faces the light emitting surface 247a of the light emitting device 247, and the first optical signal LS1 emitted from the light emitting device 247 is guided from the base end surface 311 into the first optical transmission line 31. Further, a base end surface 321 of the second optical transmission line 32 faces the light receiving surface 248a of the light receiving device 248, and the second optical signal LS2 propagating in the second optical transmission line 32 and emitted from the base end surface 321 is received by the light receiving device 248. The first optical transmission line 31 and the second optical transmission line 32 are respectively optical fibers. As described above, the first, second optical transmission lines 31, 32 are the optical fibers, and thereby, the configurations of the first, second optical transmission lines 31, 32 may be simpler and the first, second optical signals LS1, LS2 may be efficiently transmitted.

According to the second embodiment, the same advantages as those of the above described first embodiment may be offered.

### Third Embodiment

Next, a printer according to the third embodiment of the present disclosure will be explained.

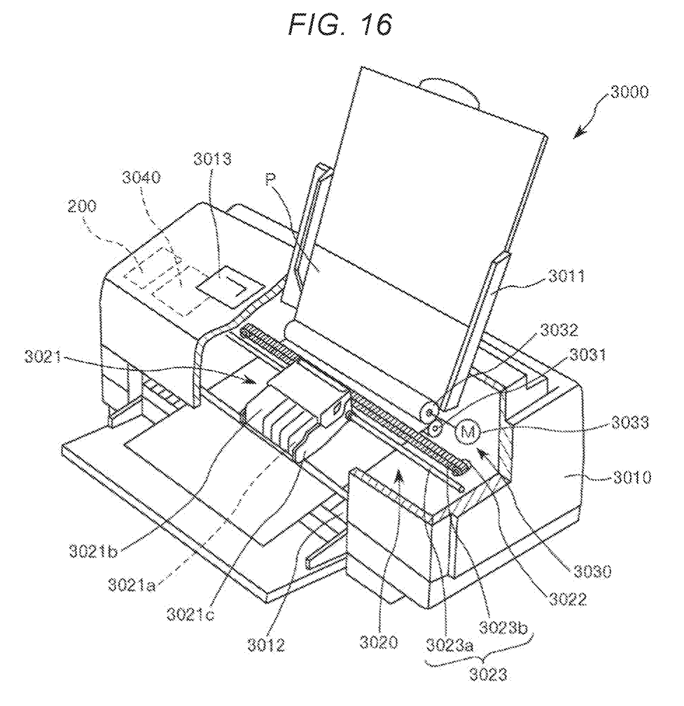

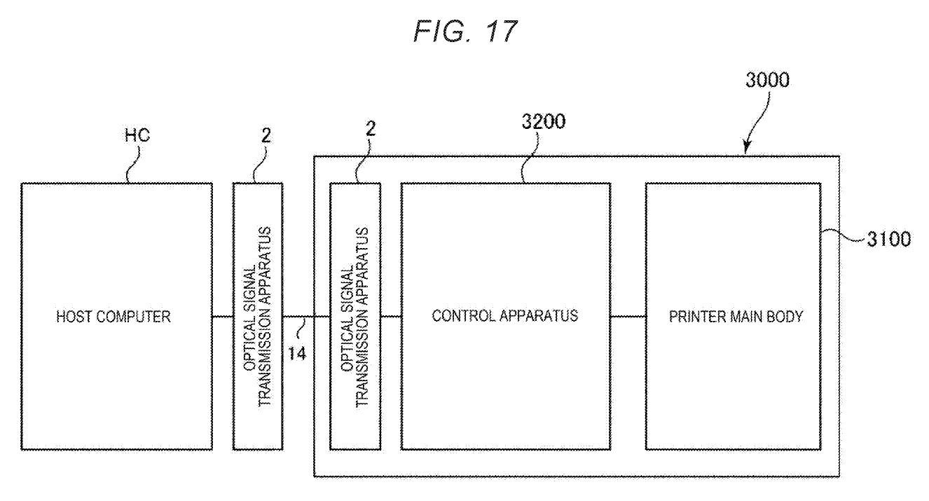

FIG. 16 is a schematic diagram showing an overall configuration of the printer according to the third embodiment of the present disclosure. FIG. 17 is a block diagram showing a control apparatus of the printer shown in FIG. 16.

A printer 3000 shown in FIG. 16 includes a housing 3010, a printer main body 3100 having a printing mechanism 3020 and a paper feed mechanism 3030 provided inside of the housing 3010, and a control apparatus 3200 that controls driving of the printer main body 3100. In the housing 3010, a tray 3011 in which recording paper P is placed, a paper eject opening 3012 through which the recording paper P is ejected, and an operation panel 3013 of a liquid crystal display or the like are provided.

The printing mechanism 3020 includes a head unit 3021, a carriage motor 3022, and a reciprocation mechanism 3023 that reciprocates the head unit 3021 by drive power of the carriage motor 3022. The head unit 3021 has a head 3021a as an inkjet recording head, an ink cartridge 3021b that supplies ink to the head 3021a, and a carriage 3021c on which the head 3021a and the ink cartridge 3021b are mounted.

The reciprocation mechanism 3023 has a carriage guide shaft 3023a that reciprocably supports the carriage 3021c and a timing belt 3023b that moves the carriage 3021c on the carriage guide shaft 3023a by the drive power of the carriage motor 3022. The paper feed mechanism 3030 has a driven roller 3031 and a driving roller 3032 in press contact with each other, and a motor 3033 that drives the driving roller 3032.

In the printer main body 3100, the paper feed mechanism 3030 intermittently feeds the recording paper P one by one to the vicinity of the lower part of the head unit 3021. Concurrently, the head unit 3021 reciprocates in directions substantially orthogonal to the feed direction of the recording paper P, and printing on the recording paper P is performed.

The control apparatus 3200 is a personal computer or the like, and controls driving of the respective parts of the printer main body 3100. The control is executed based on print data input from a host computer HC such as a personal computer, for example.

Further, as shown in FIG. 17, the printer 3000 has the optical signal transmission apparatus 2 electrically coupled to the control apparatus 3200, and communicates with the host computer HC via the optical signal transmission apparatus 2.

As described above, the printer 3000 has the optical signal transmission apparatus 2 that transmits optical signals. Further, the optical signal transmission apparatus 2 has the light emitting device 247 that emits light, the light receiving device 248 that receives the light and outputs a signal, and the amplifier circuit 249 that amplifies the signal (current signal) output from the light receiving device 248. The amplifier circuit is placed between the light emitting device 247 and the light receiving device 248. The printer 3000 has the optical signal transmission apparatus 2, and thereby, the advantages of the optical signal transmission apparatus 2 explained in the above described first embodiment may be offered. Accordingly, the optical signal transmission apparatus 2 can be stably driven and the printer 3000 may be downsized.

As above, the robot, printer, optical signal transmission apparatus of the present disclosure are explained based on the illustrated embodiments, however, the present disclosure is not limited to those. The configurations of the respective parts may be replaced by arbitrary configurations having the same functions. Further, other arbitrary configurations may be added to the present disclosure. Furthermore, the above described respective embodiments may be appropriately combined.

In the above described embodiments, the configuration of the robot 1 as the six-axis robot is explained, however, the robot 1 is not particularly limited to, but includes e.g. a dual-arm robot, scalar robot, etc.

What is claimed is:

1. A robot comprising an optical signal transmission apparatus that transmits optical signal,
the optical signal transmission apparatus including:
a light emitting device that emits light;
a light receiving device that receives light and outputs a signal; and
an amplifier circuit that amplifies the signal output from the light receiving device, wherein
the amplifier circuit is placed between the light emitting device and the light receiving device.

2. The robot according to claim 1, wherein
a distance between the light receiving device and the amplifier circuit is smaller than a distance between the light emitting device and the amplifier circuit.

3. The robot according to claim 1, further comprising:
a first optical transmission line that transmits light emitted from the light emitting device; and
a second optical transmission line that transmits light toward the light receiving device.

4. The robot according to claim 3, wherein
the first optical transmission line and the second optical transmission line are respectively polymer optical waveguides.

5. The robot according to claim 3, wherein
the first optical transmission line and the second optical transmission line are respectively optical fibers.

6. The robot according to claim 1, further comprising a package having an internal space, wherein
the light emitting device, the light receiving device, and the amplifier circuit are housed in the internal space.

7. The robot according to claim 6, wherein
the internal space is sealed.

8. The robot according to claim 6, wherein
the package has:
a base having a concave portion, in which the light emitting device, the light receiving device, and the amplifier circuit are placed above a bottom surface of the concave portion; and
a lid joined to the base to close an opening of the concave portion, and
the base is formed using ceramics.

9. The robot according to claim 6, wherein
when a direction in which the light emitting device and the light receiving device are arranged is a first direction and a direction crossing the first direction is a second direction,
the package has a plurality of terminals arranged on both sides in the second direction with respect to an area in which the light emitting device, the light receiving device, and the amplifier circuit are placed.

10. A printer comprising an optical signal transmission apparatus that transmits optical signals,
the optical signal transmission apparatus including:
a light emitting device that emits light;
a light receiving device that receives light and outputs a signal; and
an amplifier circuit that amplifies the signal output from the light receiving device, wherein
the amplifier circuit is placed between the light emitting device and the light receiving device.

11. An optical signal transmission apparatus comprising:
a light emitting device that emits light;
a light receiving device that receives light and outputs a signal; and
an amplifier circuit that amplifies the signal output from the light receiving device, wherein
the amplifier circuit is placed between the light emitting device and the light receiving device.
